(19) United States
(12) Patent Application Publication
(10) Pub. No.: US 2009/0145317 A1
(43) Pub. Date: Jun. 11, 2009

(54) METHOD OF FABRICATING IMAGE FORMING ELEMENT USING IMPRINTING PROCESS, IMAGE FORMING ELEMENT FABRICATED BY THE METHOD, AND IMPRINTING SYSTEM

(75) Inventors: Kyu-ho SHIN, Seoul (KR); Eung-yeoul Yoon, Suwon-si (KR); Jin-seung Choi, Suwon-si (KR); Kahp-yang Suh, Seoul (KR); Moon-kyu Kwak, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/123,596

(22) Filed: May 20, 2008

(30) Foreign Application Priority Data
Dec. 7, 2007 (KR) 2007-126643

(51) Int. Cl. B41N 3/00

(52) U.S. Cl. 101/401.1

(57) ABSTRACT

A method of fabricating an image forming element includes preparing an image drum, transferring conductive ink as a pre-form of a plurality of ring electrodes on an outer circumference of the image drum using an imprinting process, solidifying the conductive ink on the outer circumference of the image drum to form the plurality of ring electrodes, and forming an outer insulating layer on the outer circumference of the image drum having the plurality of ring electrodes.

### CROSS-REFERENCE TO RELATED APPLICATIONS

This application claims the benefit under 35 U.S.C. § 119(a) from Korean Patent Application No. 2007-126643 filed Dec. 7, 2007 in the Korean Intellectual Property Office, the disclosure of which is incorporated herein in its entirety by reference.

### BACKGROUND OF THE INVENTION

1. Field of the Invention

The present general inventive concept relates to an image forming element for use in a direct printing type image forming apparatus, and more particularly, to a method of fabricating an image forming element using an imprinting process, an image forming element fabricated by the method, and an imprinting system to achieve the imprinting.

2. Description of the Related Art

Generally, a direct printing type image forming apparatus employs a process of directly applying an image signal onto an image forming element to form a latent image thereon, and developing the latent image into a visible form. Unlike the electrophotographic type image forming apparatus, the direct printing type image forming apparatus does not require processes such as light exposure or charging, and provides stable processing, and therefore is consistently studied in the industry.

A direct printing type image forming apparatus generally employs a cylindrical image drum as an image forming element, along with a plurality of ring electrodes formed on an outer circumference of the image drum and a control circuit board formed inside the image drum in electrical connection with the ring electrodes.

The image drum is generally formed from aluminum or an aluminum alloy. The ring electrodes are insulated from neighboring ring electrodes and also from the image drum by a presence of an insulating layer formed on the outer circumference of the image drum. The ring electrodes are electrically connected to thermals provided on the control circuit board through a piercing hole formed in the image drum.

Specifically, the image drum includes a lengthwise slot formed therein, in which the control circuit board is inserted and bonded by a non-conductive adhesive. Terminals of the control circuit board are exposed to the outside through the lengthwise slot, to thereby be electrically connected to the ring electrodes formed on the outer circumference of the image drum. The control circuit board supplies a required electricity to the ring electrodes according to the image information, to thereby cause a predetermined latent image to be formed on the image forming element.

However, fabricating such an image forming element is complicated and costly since it requires processes such as a precision surface processing of the image drum, a minute pattern processing of the image drum with a laser beam, an electric beam or a diamond machining tool, an epoxy and dielectric coating, and a coating of conductive particles.

### SUMMARY OF THE INVENTION

The present general inventive concept provides a method of fabricating an image forming element, which provides a simplified processing, a reduced cost, and an increased productivity, by utilizing imprinting processing to form conductive ink on an image drum.

Additional aspects and/or utilities of the present general inventive concept will be set forth in part in the description which follows and, in part, will be obvious from the description, or may be learned by practice of the general inventive concept.

The present general inventive concept also provides an image forming element fabricated by the above method of fabricating an image forming element.

The present general inventive concept also provides an imprinting system to perform the above imprinting processing.

The foregoing and/or other aspects and utilities of the present general inventive concept may be achieved by providing a method of fabricating an image forming element, which includes preparing an image drum, transferring conductive ink as a pre-form of a plurality of ring electrodes on an outer circumference of the image drum using an imprinting process, solidifying the conductive ink on the outer circumference of the image drum to form the plurality of ring electrodes, and forming an outer insulating layer on the outer circumference of the image drum having the plurality of ring electrodes.

The transferring the conductive ink may include preparing a cylindrical mold in which convex patterns are formed, the convex patterns having a corresponding pitch to that of the plurality of ring electrodes, coating the conductive ink on the convex patterns of the cylindrical mold, and placing the cylindrical mold to a proximity substantially in parallel to the image drum and rotating the cylindrical mold and the image drum in relation to each other.

The coating the conductive ink may include rotating the convex patterns of the cylindrical mold in contact, while the ink roller is rotated with one portion thereof is submerged in the conductive ink held in an ink reservoir, so that the conductive ink is transferred from the outer circumference of the ink roller onto the convex patterns.

The coating the conductive ink may further include blading the coating of the conductive ink to a predetermined constant thickness on the ink roller.

The surface energies of the ink roller, the cylindrical mold, and the image drum may meet the following mathematical expression:

Ink roller<cylindrical mold<image drum (1)

The cylindrical mold may be formed from poly dimethyl siloxane (PDMS). The conductive ink may be mainly formed from silver (Ag).

The height (h) of the convex patterns of the cylindrical mold may be larger than 30t (where ‘t’ denotes a thickness of the conductive ink coated on the ink roller).

The transferring the conductive ink may include preparing a plate type mold on which convex patterns are formed at a pitch corresponding to that of the plurality of ring electrodes, coating the conductive ink on the convex patterns of the plate type mold, and moving the plate type mold and the image drum to a proximity to each other so that the conductive ink coated on the convex patterns of the plate type mold is transferred onto the image drum due to a difference of surface energies between the plate type mold and the image drum.

The solidifying the conductive ink may use a radiant heat from a heating lamp or an ultraviolet ray.

The foregoing and/or other aspects and utilities of the present general inventive concept may be achieved by providing a method of fabricating an image forming element which includes preparing an image drum having a first surface energy, coating a conductive ink over an entire part of an outer circumference of the image drum, preparing a cylindrical mold having a plurality of convex patterns formed at a pitch corresponding to that of a plurality of ring electrodes to be later formed on the image drum, the cylindrical mold having a second surface energy greater than the first surface energy of the image drum, placing the cylindrical mold and the image drum to a proximity to each other, and rotating the cylindrical mold and the image drum with respect to each other so that the coating of the conductive ink is partially removed from the image drum, solidifying the remaining conductive ink on the image drum to form the plurality of ring electrodes, and coating an outer insulating layer on the outer circumference of the image drum on which the plurality of ring electrodes are completely formed.

The foregoing and/or other aspects and utilities of the present general inventive concept may be achieved by providing an image forming element fabricated as described above.

The foregoing and/or other aspects and utilities of the present general inventive concept may be achieved by providing an imprinting system which includes a drum holder to rotatably support an image drum, an ink roller to rotate, which one portion thereof is submerged in conductive ink held in an ink reservoir, and a cylindrical mold to rotate relatively between the ink roller and the image drum, the cylindrical mold having a plurality of convex patterns formed at a pitch to correspond to that of a plurality of ring electrodes to be later formed on the image drum so that the conductive ink on the surface of the ink roller is transferred onto the image drum via the convex patterns.

The surface energy of the cylindrical mold may be smaller than that of the image drum, and the surface energy of the ink roller may be smaller than that of the cylindrical mold.

The imprinting system may further include a blade arranged at a predetermined distance from the ink roller to restrict the coating of the conductive ink to a predetermined thickness.

The imprinting system may further include a means to solidify the conductive ink transferred onto the outer circumference of the image drum.

The imprinting system may further include an alignment stage having a vision system to align the image drum and the cylindrical mold.

The height (h) of the convex patterns of the cylindrical mold may be larger than 30t (where ‘t’ denotes a thickness of the conductive ink coated on the ink roller).

The cylindrical mold may be formed from poly dimethyl siloxane (PDMS).

The foregoing and/or other aspects and utilities of the present general inventive concept may be achieved by providing an imprinting system which includes a drum holder to rotatably support an image drum, a plate type mold movable in relation to the image drum, and having a plurality of convex patterns formed at a pitch to correspond to that of a plurality of ring electrodes to be later formed on the image drum, and an ink roller to supply conductive ink onto the convex patterns of the plate type mold, wherein the conductive ink is transferred from the convex patterns of the plate type mold onto the image drum.

### BRIEF DESCRIPTION OF THE DRAWINGS

These and/or other aspects and utilities of the present general inventive concept will become apparent and more readily appreciated from the following description of the exemplary embodiments, taken in conjunction with the accompanying drawings of which:

FIGS. 1A and 1B are respectively a perspective view and a cross-section view illustrating a cylindrical mold for use in a method of fabricating an image forming element according to an exemplary embodiment of the present general inventive concept;

FIGS. 2A and 2B are respectively a perspective view and a cross-section view of the cylindrical mold of FIGS. 1A and 1B having a coating of a conductive ink;

FIGS. 2C and 2D are respectively a perspective view and a cross-section view of an example of coating conductive ink uniformly on the cylindrical mold of FIGS. 2A and 2B;

FIGS. 3A and 3B are respectively a perspective view and a cross-section view of an image drum used in a method of fabricating an image forming element according to an exemplary embodiment of the present general inventive concept;

FIG. 3C is a perspective view of a control circuit board installed within the image drum of FIG. 3A;

FIGS. 4A and 4B are respectively a perspective view and a cross-section view illustrating stages in which the coating of the conductive ink is transferred from the convex patterns of the cylindrical mold onto the outer circumference of the image drum, and solidified to form ring electrodes;

FIGS. 5A and 5B are respectively a perspective view and a cross-section view illustrating stages in which outer insulating layer is formed on the outer circumference of the image drum on which the ring electrodes are formed;

FIGS. 6A to 6E are views illustrating the processes of a method of fabricating an image forming element according to an exemplary embodiment of the present general inventive concept;

FIGS. 7A through 7C are cross-section views illustrating the imprinting process employing attachment;

FIGS. 8A through 8C are cross-section views illustrating the imprinting process employing detachment; and

FIG. 9 is a cross-section view provided to illustrate a dimensional relationship of the cylindrical mold and the conductive ink employed for the imprinting according to an exemplary embodiment of the present general inventive concept.

### DETAILED DESCRIPTION OF THE PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The matters defined in the description, such as a detailed construction and elements thereof, are provided to assist in a comprehensive understanding of the general inventive concept. Thus, it is apparent that the general inventive concept may be carried out without those defined matters. Also, well-known functions or constructions are omitted to provide a clear and concise description of exemplary embodiments recited herein.

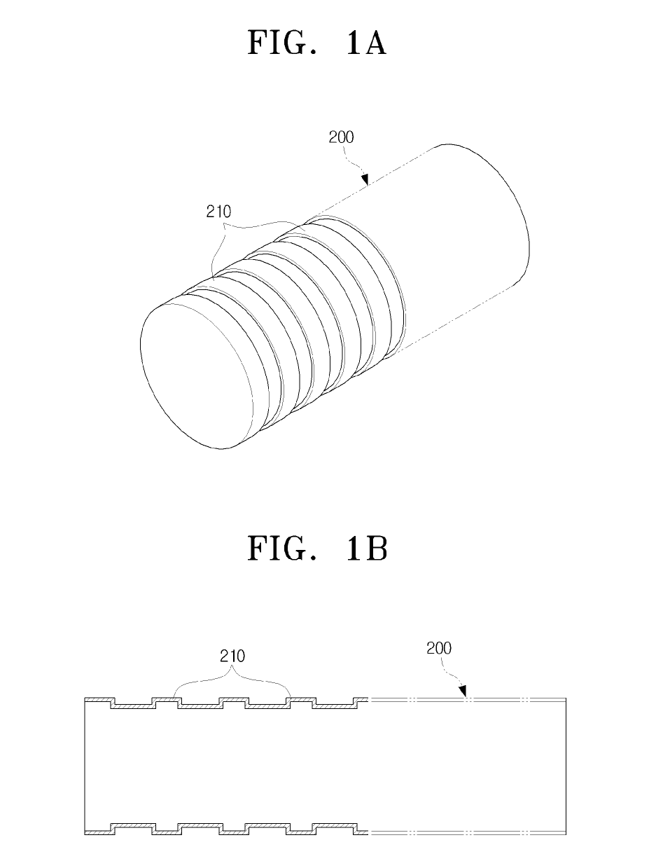

FIGS. 1A through 5B are views illustrating a method of fabricating an image forming element according to an exemplary embodiment of the present general inventive concept.

FIGS. 1A and 1B illustrate stages in which a cylindrical mold 200, having convex patterns 210 formed thereon, is fabricated. Specifically, FIG. 1A is a perspective view of the cylindrical mold 200 and FIG. 1B is a cross-section view of FIG. 1A.

In the stage of fabricating the cylindrical mold 200 with reference to FIG. 1A, the cylindrical mold 200, having the convex patterns 210, is prepared. Specifically, the convex patterns 210 provide a template having a plurality of spaced rings formed along an axis direction, such as a longitudinal direction, of the cylindrical mold 200. The convex patterns 210 are used in the ring electrode imprinting process which will be explained in detail below.

In exemplary embodiments, the convex patterns 210 provide minute alignment templates to form the ring electrodes 122 capable of forming a high-resolution image. In an exemplary embodiment, the convex patterns 210 may include a width of approximately 20 μm and a pitch of approximately 42.3 μm. However, the present general inventive concept is not limited thereto. In an exemplary embodiment, the convex patterns 210 may be formed by general etching or machining methods.

In exemplary embodiments, the cylindrical mold 200 may be formed from a rigid material, or from a flexible material as necessary. In an exemplary embodiment, the cylindrical mold 200 may be formed from poly dimethyl siloxane (PDMS). However, the present general inventive concept is not limited thereto.

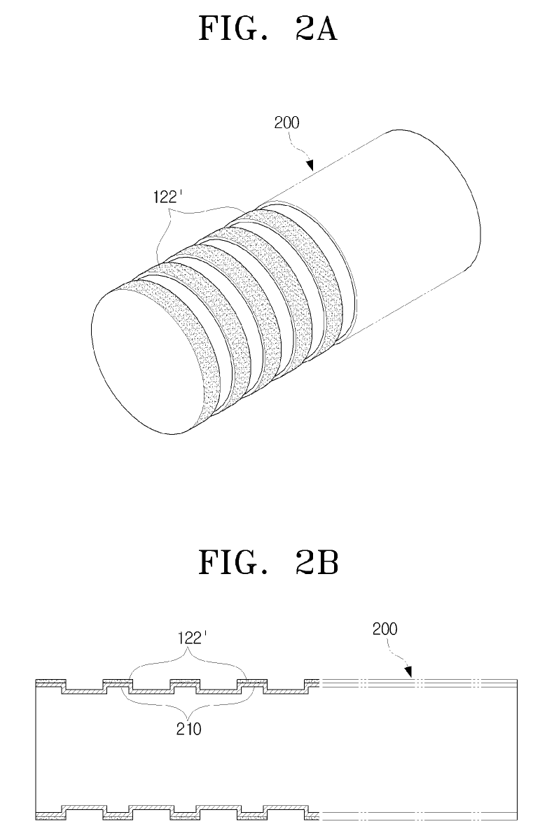

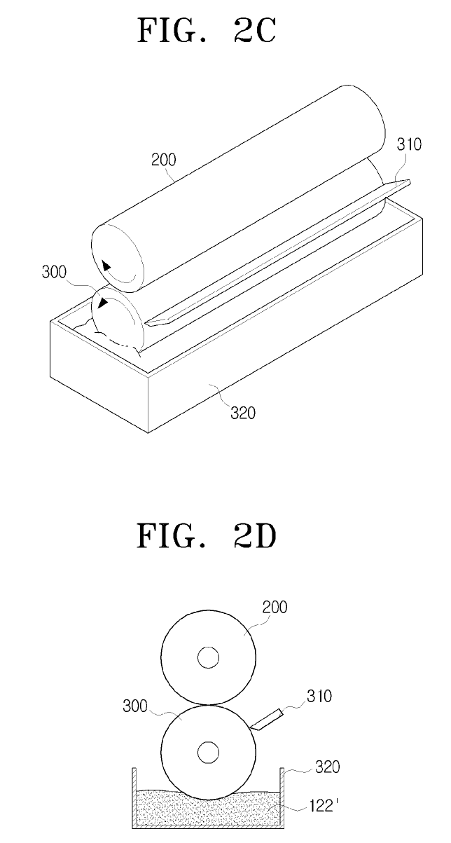

FIGS. 2A through 2D illustrate a stage of coating a conductive ink 122′ on the convex patterns 210 of the cylindrical mold 200. Specifically, FIG. 2A is a perspective view of the cylindrical mold 200 having a coating of conductive ink 122′, and FIG. 2B is a cross-section view of FIG. 2A. FIG. 2C is a perspective view illustrating an example of a method used to uniformly coat the conductive ink 122′ on the cylindrical mold 200, and FIG. 2D is a cross-section view of FIG. 2C.

Referring to FIGS. 2C and 2D, in order to uniformly coat the conductive ink 122′ on the cylindrical mold 220, an ink roller 300 is partially disposed in an ink reservoir 320 holding the conductive ink 122′ therein, and rotated such that the conductive ink 122′ is coated on the ink roller 300. In an exemplary embodiment, a blade 310 may be arranged on a side of the ink roller 300 at a predetermined distance from the ink roller 300 in order to keep the coating of the conductive ink 122′ at a constant thickness. After the conductive ink 122′ is coated on the ink roller 300 to a predetermined thickness, the cylindrical mold 200 is rotated while in contact with the ink roller 300 having the coating of the conductive ink 122′ such that the conductive ink 122′ is transferred from the ink roller 300 onto the convex patterns 210 of the cylindrical mold 200.

In exemplary embodiments. the conductive ink 122′ is mainly formed from a conductive metal material such as silver (Ag), and added with various other solvents. In exemplary embodiments, the conductive ink 122′ may include different viscosities according to particular circumstances and/or other desired characteristics.

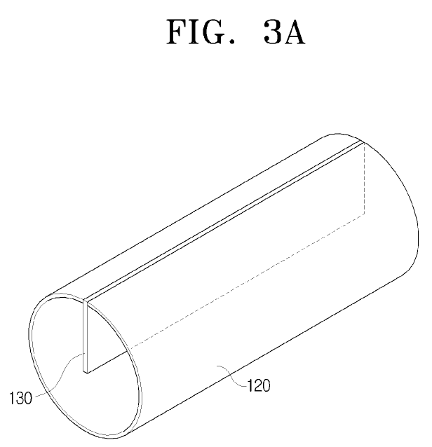

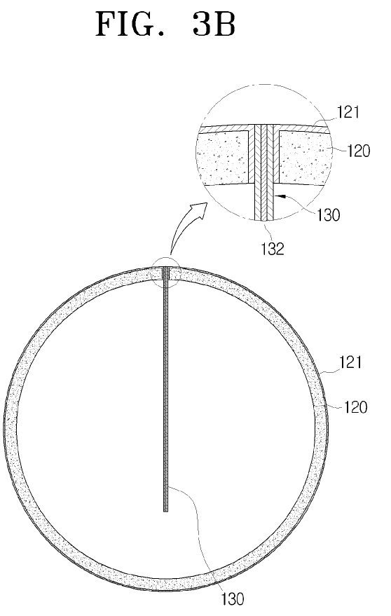

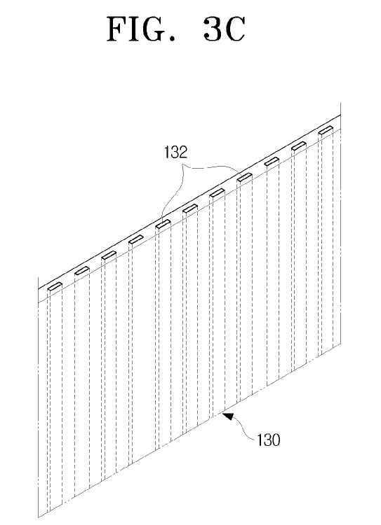

FIGS. 3A through 3C illustrates a stage of fabricating the image drum 120.

The image drum 120 is arranged in the configuration of a hollow cylinder, and an insulating layer 121 may be formed on an outer circumference of the image drum 120. In exemplary embodiments, the insulating layer 121 may be formed from various materials having different surface energies according to particular circumstances and/or other desired characteristics. In exemplary embodiments, the insulating layer 121 may be formed from SU-8, or any other general polymer having excellent electric insulating properties. In an exemplary embodiment, the insulating layer 121 may be formed on an anodized oxide layer. However, the present general inventive concept is not limited thereto.

While the insulating layer 121 is formed on the outer circumference of the image drum 120 according to the current exemplary embodiment explained above, the image drum 120 may itself be formed from an insulating material in alternative exemplary embodiments, thereby omitting the insulating layer 121.

In exemplary embodiments, the image drum 120 may be formed to house therein a board 130 with connector patterns 132 formed on the board 130. One end of the board 130 is mounted relative to the image drum 120 in a manner such that one end of each connector pattern 132 is exposed outside of the image drum 120.

Referring to FIG. 3C, the connector patterns 132 are arranged in a linear configuration and are formed coplanar with respect to each other at predetermined intervals. While the connector patterns 132 are housed in the board 130 formed from an insulating material in the current exemplary embodiment explained herein, at least one end of each connector pattern 132 may be exposed outside of the side of the board 130, if necessary.

In exemplary embodiments, the board 130 may be formed from a flexible material, and the connector patterns 132 are arranged in a minute alignment pattern in which the connector patterns 132 are spaced apart at minute intervals from each other. In an exemplary embodiment, the connector patterns 132 may be formed at pitches of about 42.3 μm to correspond to the pitches of the ring electrodes 122, which will be formed later. In exemplary embodiments, a flexible printed circuit board (FPCB) may be implemented as the board 130, or in alternative exemplary embodiments, the board 130 may be formed from a rigid material which enables formation of connector patterns 132 in a minute alignment.

In exemplary embodiments, the board 130 may be arranged in a substantially linear relation with the drum 120 and disposed inside the image drum 120. In an alternative exemplary embodiment, the board 130, in a wound, folded, or bent form, may be provided inside the image drum 120.

In exemplary embodiments, the board 130 may serve as a connecting medium between the ring electrodes 122 formed on the outer circumference of the image drum 120 and the interior of the image drum 120. If necessary, a control element (not illustrated) which is used to electrically control the ring electrodes 122 may be integrally formed on the board 130. The board 130 integrated with the control element (not illustrated) may include a circuit to control the ring electrodes 122 in association with the control element (not illustrated), as well as serving as a connecting medium between the ring electrodes 122 and the interior of the image drum 120. The control element (not illustrated) may include a plurality of control chips, such as an application-specific integrated circuit (ASIC) to enable independent supply of the electric voltage to the respective ring electrodes 122. However, the present general inventive concept is not limited thereto.

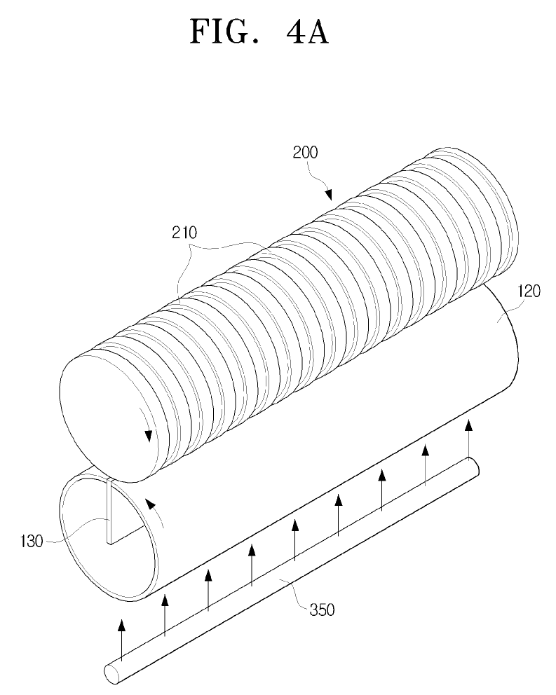

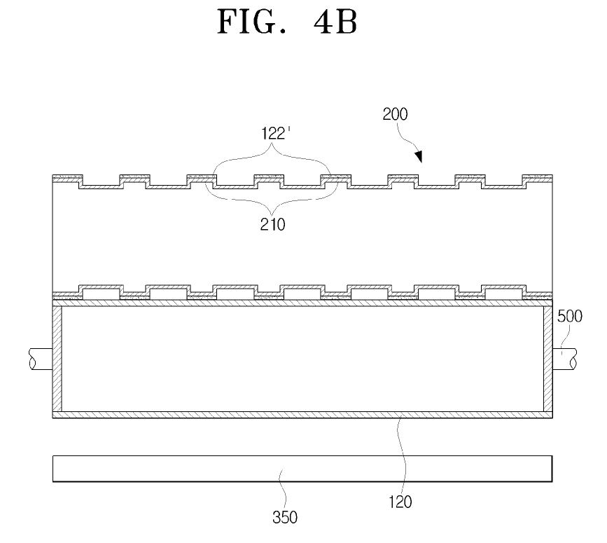

FIGS. 4A and 4B illustrate the stages in which the coating of the conductive ink 122′ on the convex patterns 210 of the cylindrical mold 200 is transferred onto the outer circumference of the image drum 120, and solidified to form the ring electrodes 122.

In order to transfer the coating of conductive ink 122′ from the convex patterns 210 of the cylindrical mold 200 onto the image drum 120, the cylindrical mold 200 and the image drum 120 are placed substantially in parallel and in close relation to each other and rotated so that the coating of the conductive ink 122′ of the convex patterns 210 of the cylindrical mold 200 is imprinted on the outer circumference of the image drum 120. In exemplary embodiments, the image drum 120 may be kept at a predetermined distance from the outer circumference of the cylindrical mold 200 by a drum holder 500 and rotated. In alternative exemplary embodiments, the image drum 120 may be rotated while in contact with the outer circumference of the cylindrical mold 200. Although not illustrated, the imprinting system of conductive ink may employ an alignment stage equipped with a vision system for the alignment of the cylindrical mold 200 and the image drum 120.

In exemplary embodiments, the viscosity and a transfer characteristic of the conductive ink 122′ may vary with respect to the cylindrical mold 200 and the image drum 120, depending on a magnitude of the surface energy between the cylindrical mold 200 and the image drum 120. The conductive ink 122′ is transferred more efficiently, if the surface energy of the image drum 120 is greater than that of the convex patterns 210 of the cylindrical mold 200. In an exemplary embodiment, if the insulating layer 120 on the outer circumference of the image drum 120 is formed from SU-8 having surface energy of about 30 mj/m2, the convex patterns 210 of the cylindrical mold 200 are formed from a poly ethylene terephthalate (PETE) with a surface energy of about 19 mj/m2, a poly ethylene dioxythiophene (PEDOT) with a surface energy of about 28 mj/m2, or a poly dimethyl siloxane (PDMS) with a surface energy of about 20 mj/m2, in order to keep the surface energy of the convex patterns 210 of the cylindrical mold 200 below about 30 mj/m2. In considering the formability of the mold, the PDMS is desirable in an exemplary embodiment.

As the conductive ink 122′ of the cylindrical mold 200 is transferred onto the outer circumference of the image drum 120, the conductive ink 122′ is electrically connected to certain portions of the connector patterns 132 exposed outside the image drum 120. The connector patterns 132 include a same width and pitch as those of the conductive ink 122′ transferred onto the outer circumference of the image drum 120, to electrically correspond to the conductive ink 122′, individually.

After the conductive ink 122′ is transferred onto the image drum 120, thermal processing is carried out to solidify the conductive ink 122′ on the outer circumference of the image drum 120. As a result, a plurality of ring electrodes 122 is formed on the outer circumference of the image drum 120. In exemplary embodiments, the thermal processing may refer to a general curing process, and in the current exemplary embodiment of the present general inventive concept, a heating lamp 350 applies heat to the conductive ink 122′ on the outer circumference of the image drum 120 to volatilize solvent contained in the conductive ink 122′ and to thereby form the plurality of ring electrodes 122. In exemplary embodiments, the solidification may employ ultraviolet ray, instead of radiant heat of the heating lamp 350. However, the present general inventive concept is not limited thereto.

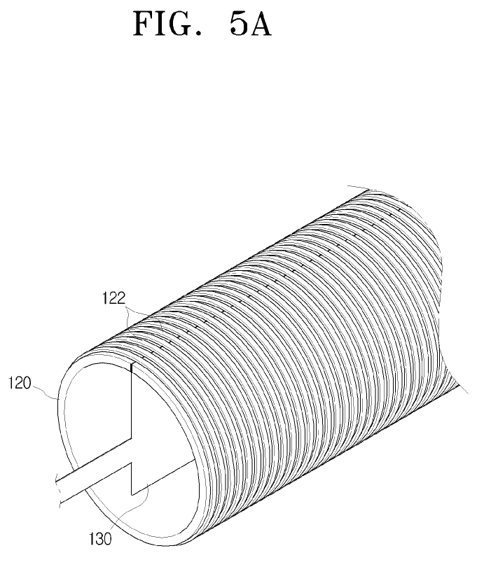

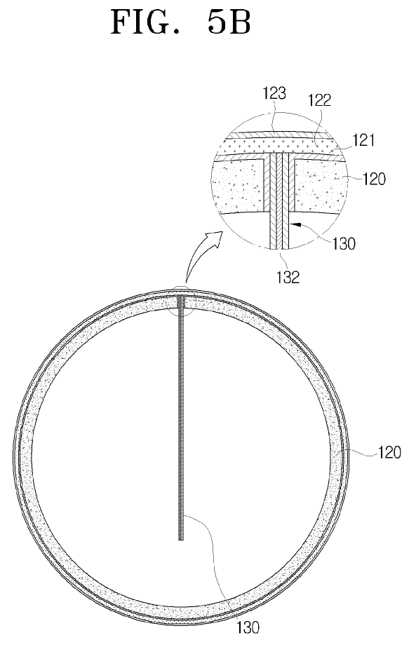

FIGS. 5A and 5B illustrate a stage of completing the image forming element 110 by forming an outer insulating layer 123 on the outer circumference of the image drum 120 having the plurality of ring electrodes 122 formed thereon. In an exemplary embodiment, the outer insulating layer 123 may be formed from a dielectric material and cover the plurality of ring electrodes 122.

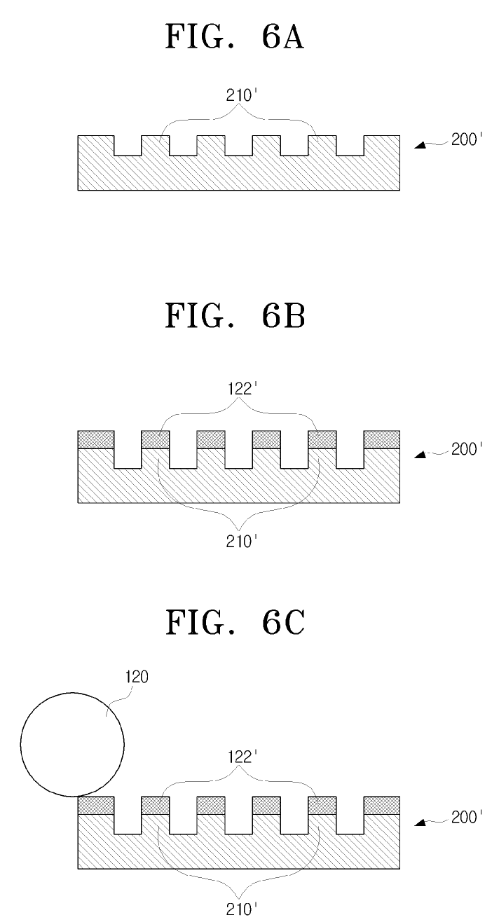

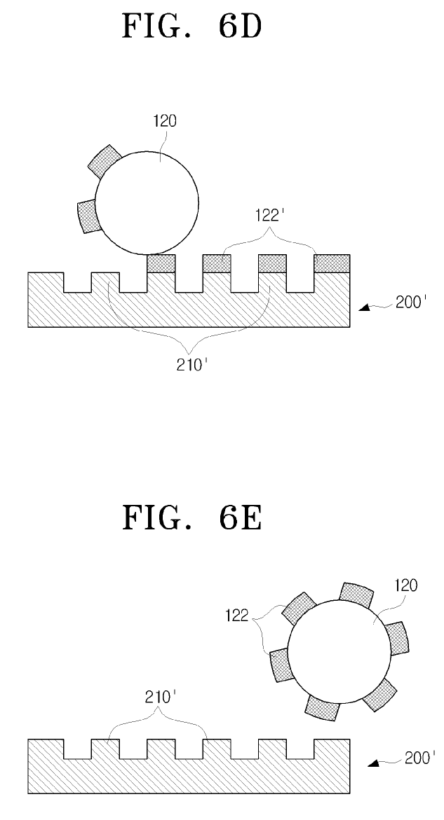

A method of fabricating an image forming element 110 according to an exemplary embodiment of the present general inventive concept has been explained above, in which the ring electrodes 122 are formed by transferring the conductive ink 122′ onto the image drum 120 using the cylindrical mold 200 having a plurality of convex patterns 210. However, other alternative exemplary embodiments are possible such as an example illustrated in FIGS. 6A through 6E, in which the conductive ink 122′ is transferred onto the image drum 120 using a plate mold 200′. This alternative exemplary embodiment will now be explained in detail below, mainly focusing on the imprinting process, with reference to FIGS. 6A through 6E.

FIG. 6A illustrates the plate mold 200′ in which a plurality of convex patterns 210′ are formed. FIG. 6B illustrates a state in which the conductive ink 122′ is coated on the plurality of convex patterns 210′ of the plate mold 200′, using the ink supply means such as ink roller 300 as explained above (see FIG. 2C). Accordingly, referring to FIG. 6C, as the image drum 120 is rotated, while in contact with the plate mold 200′ on which the conductive ink 122′ is coated to a predetermined thickness on the convex patterns 210′, the coating of the conductive ink 122′ is transferred from the plate mold 200′ onto the image drum 120 as illustrated in FIG. 6D. FIG. 6E illustrates a state in which all of the conductive ink 122′ is transferred from the plurality of convex patterns 210′ of the plate mold 200′ onto the image drum 120 after one rotation of the image drum 120 in contact with the plate mold 200′.

After that, the conductive ink 122′ is solidified on the image drum 120 by an appropriate solidifying means such as a heating lamp 350 (see FIG. 4A), so that the plurality of ring electrodes 122 are formed.

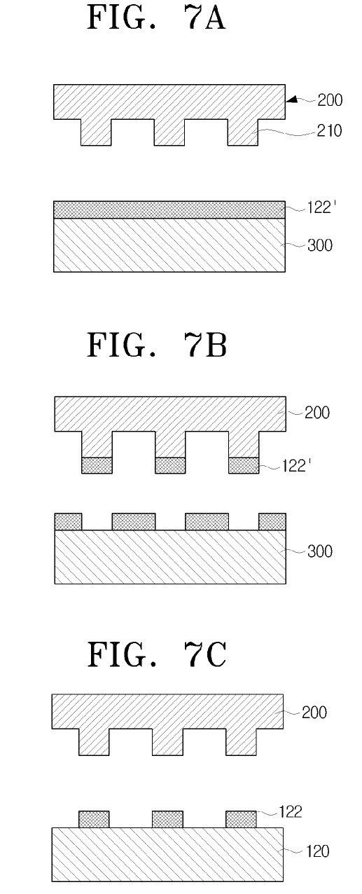

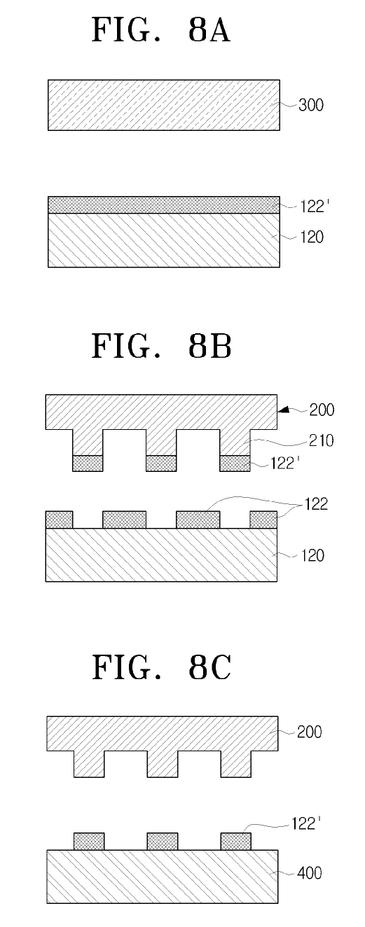

FIGS. 7A through 7C illustrate a method of fabricating an image forming element using an imprinting process involving an attachment process, in which the conductive ink 122′ is coated on the plurality of convex patterns 210 and 210′ of the cylindrical mold 200 or the plate mold 200′, and the conductive ink 122′ is transferred onto the image drum 120. FIGS. 8A through 8C illustrate an example of an imprinting process involving a detachment process, in which the conductive ink 122′ is coated entirely over the outer circumference of the image drum 120, and the coating of the conductive ink 122′ is partially removed.

Specifically, FIGS. 7A through 7C illustrate the imprinting process involving an attachment process, and FIGS. 8A through 8C illustrate the imprinting process involving a detachment process. In exemplary embodiments, an ink supply means 300 such as an ink roller may be provided, and a cleaning roller 400 may also be provided to clean the waste conductive ink 122′ removed from the image drum 120 in contact with the mold 200 or 200′. In exemplary embodiments, the surface energy of the image drum 120 is set to be lower than that of the mold 200 or 200′ in the imprinting involving the detachment process, since the conductive ink 122′ is coated on the image drum 120 and then partially removed by using the mold.

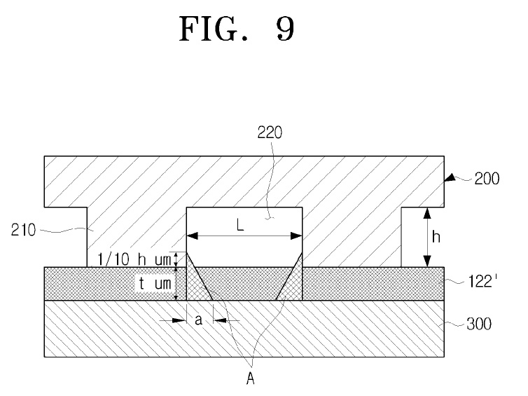

FIG. 9 is provided to illustrate a principle that enables the conductive ink 122′ of the ink roller 300 to move onto the cylindrical mold 200, and a dimension of the cylindrical mold 200 to enable a limited coating of the conductive ink 122′ to the convex patterns 210 of the cylindrical mold 200. The cylindrical mold 200 has dimensions determined in consideration of the surface energy or thickness of the coating of the conductive ink, or the material of the mold, in order to enable the exclusive coating of the conductive ink onto the convex patterns 210.

Referring to FIG. 9, the experiment has proven that the convex patterns 210 need to have a height (h) so determined that ‘a’ can be greater than 4, in consideration of the dewetting of the conductive ink 122′. The ‘dewetting’ refers to a process in which the portion A of FIG. 9 is transferred onto concaves 220 and area of 1/10 h of the mold. Without the dewetting, the conductive ink 122′ on the convex patterns 210 is attached back to the ink roller 300 and so it is difficult to exclusively coat the conductive ink 122′ on the convex patterns 210.

Furthermore, it has been proven from the experiment that the exclusive coating of the conductive ink 122′ on the convex patterns 210 of the mold is possible without requiring a separate surface processing such as plasma processing, if the condition of h≧30t is satisfied (where ‘t’ denotes the thickness of the conductive ink 122′).

Furthermore, according to the capillary wave theory, the following mathematical expression is established,

$${q}_{c} = {( \frac{{A}_{eff}}{2 π {y}^{4}} )}^{\frac{1}{2}}$$

and the wave length is expressed by,

$$λ = \frac{2 π}{{q}_{c}} = {( \frac{8 {π}^{3} {yt}^{4}}{{A}_{eff}} )}^{\frac{1}{2}}$$

Since the pitch of the convex patterns 210 is fixed at about 42.3 μm, the wave length is about 84.6 μm, and this relation can be expressed by,

$$λ = \frac{2 π}{{q}_{c}} = {( \frac{8 {π}^{3} {yt}^{4}}{{A}_{eff}} )}^{\frac{1}{2}}$$

where ‘t’ denotes the thickness of the conductive ink 122′, ‘y’ denotes a surface energy of the conductive ink 122′, and ‘Aeff’ denotes the effective Hamaker constant.

According to the above mathematical expressions, the upper limit of the thickness of the conductive ink 122′ is obtained by fixing the surface energy of the conductive ink 122′, and the upper limit of the surface energy of the conductive ink 122′ is obtained by fixing the thickness of the conductive ink 122′.

In the exemplary embodiments explained above, the mold is formed from the poly dimethyl siloxane (PDMS), the convex patterns 210 of the mold are formed to have a height (h) of 15 μm, and the conductive ink 122′ is coated to the thickness approximately of 0.5 μm. After testing this specification, it has been confirmed that the conductive ink 122′ has been coated exclusively to the convex patterns 210 of the mold by approximately 0.3 μm. Furthermore, after testing the transfer of the conductive ink 122′ from the mold onto the image drum 120, it has been confirmed that a smooth ink transfer has been made.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A method of fabricating an image forming element, the method comprising:
preparing an image drum;
transferring conductive ink as a pre-form of a plurality of ring electrodes on an outer circumference of the image drum using an imprinting process;
solidifying the conductive ink on the outer circumference of the image drum to form the plurality of ring electrodes; and
forming an outer insulating layer on the outer circumference of the image drum having the plurality of ring electrodes.

2. The method of claim 1, wherein the transferring the conductive ink comprises:
preparing a cylindrical mold in which convex patterns are formed, the convex patterns having a corresponding pitch to that of the plurality of ring electrodes;
coating the conductive ink on the convex patterns of the cylindrical mold; and
placing the cylindrical mold to a proximity substantially in parallel to the image drum and rotating the cylindrical mold and the image drum in relation to each other.

3. The method of claim 2, wherein the coating the conductive ink comprises rotating the convex patterns of the cylindrical mold in contact, while an ink roller is rotated with one portion thereof being submerged in the conductive ink held in an ink reservoir, so that the conductive ink is transferred from the outer circumference of the ink roller onto the convex patterns.

4. The method of claim 3, wherein the coating the conductive ink further comprises blading the coating of the conductive ink to a predetermined constant thickness on the ink roller.

5. The method of claim 3, wherein surface energies of the ink roller, the cylindrical mold, and the image drum meet the following mathematical expression:
Ink roller<cylindrical mold<image drum (1)

6. The method of claim 5, wherein the cylindrical mold is formed from poly dimethyl siloxane (PDMS).

7. The method of claim 5, wherein the conductive ink is mainly formed from silver (Ag).

8. The method of claim 3, wherein a height (h) of the convex patterns of the cylindrical mold is larger than 30t (where ‘t’ denotes a thickness of the conductive ink coated on the ink roller).

9. The method of claim 1, wherein the transferring the conductive ink comprises:
preparing a plate type mold on which convex patterns are formed at a pitch corresponding to that of the plurality of ring electrodes;
coating the conductive ink on the convex patterns of the plate type mold; and
moving the plate type mold and the image drum to a proximity to each other so that the conductive ink coated on the convex patterns of the plate type mold is transferred onto the image drum due to a difference of surface energies between the plate type mold and the image drum.

10. The method of claim 1, wherein the solidifying the conductive ink uses a radiant heat from a heating lamp or an ultraviolet ray.

11. A method of fabricating an image forming element, the method comprising:
preparing an image drum having a first surface energy;
coating a conductive ink over an entire part of an outer circumference of the image drum;
preparing a cylindrical mold having a plurality of convex patterns formed at a pitch corresponding to that of a plurality of ring electrodes to be later formed on the image drum, the cylindrical mold having a second surface energy greater than the first surface energy of the image drum;
placing the cylindrical mold and the image drum to a proximity to each other, and rotating the cylindrical mold and the image drum with respect to each other so that the coating of the conductive ink is partially removed from the image drum;
solidifying the remaining conductive ink on the image drum to form the plurality of ring electrodes; and
coating an outer insulating layer on the outer circumference of the image drum on which the plurality of ring electrodes are completely formed.

12. An image forming element fabricated according a method which includes preparing an image drum, transferring conductive ink as a pre-form of a plurality of ring electrodes on an outer circumference of the image drum using an imprinting process, solidifying the conductive ink on the outer circumference of the image drum to form the ring electrode, and forming an outer insulating layer on the outer circumference of the image drum having the plurality of ring electrodes.

13. An imprinting system comprising:
a drum holder to rotatably support an image drum;
an ink roller to rotate, which one portion thereof is submerged in conductive ink held in an ink reservoir; and
a cylindrical mold to rotate relatively between the ink roller and the image drum, the cylindrical mold having a plurality of convex patterns formed at a pitch to correspond to that of a plurality of ring electrodes to be later formed on the image drum so that the conductive ink on the surface of the ink roller is transferred onto the image drum via the convex patterns.

14. The imprinting system of claim 13, wherein a surface energy of the cylindrical mold is smaller than that of the image drum, and a surface energy of the ink roller is smaller than that of the cylindrical mold.

15. The imprinting system of claim 13, further comprising a blade arranged at a predetermined distance from the ink roller to restrict the coating of the conductive ink to a predetermined thickness.

16. The imprinting system of claim 13, further comprising a means to solidify the conductive ink transferred onto the outer circumference of the image drum.

17. The imprinting system of claim 13, further comprising an alignment stage having a vision system to align the image drum and the cylindrical mold.

18. The imprinting system of claim 13, wherein the height (h) of the convex patterns of the cylindrical mold is larger than 30t (where ‘t’ denotes a thickness of the conductive ink coated on the ink roller).

19. The imprinting system of claim 18, wherein the cylindrical mold is formed from poly dimethyl siloxane (PDMS).

20. An imprinting system comprising:
a drum holder to rotatably support an image drum;
a plate type mold movable in relation to the image drum, and having a plurality of convex patterns formed at a pitch to correspond to that of a plurality of ring electrodes to be later formed on the image drum; and
an ink roller to supply conductive ink onto the convex patterns of the plate type mold, wherein the conductive ink is transferred from the convex patterns of the plate type mold onto the image drum.

21. An imprinting system comprising:
a drum holder to support an image drum;
an ink roller to rotate, a portion of the ink roller is submerged in conductive ink held in an ink reservoir; and
a cylindrical mold to rotate between the ink roller and the image drum, the cylindrical mold having a plurality of protrusions formed at a pitch to correspond to that of a plurality of ring electrodes to be later formed on the image drum so that the conductive ink on the surface of the ink roller is transferred onto the image drum via the plurality of protrusions.

22. The imprinting system of claim 21, wherein the plurality of protrusions are formed in a pattern.

23. The imprinting system of claim 21, wherein the image drum includes a first surface energy and the cylindrical mold includes a second surface energy, the second surface energy of the cylindrical mold being larger than the first surface energy of the image drum.
